(19) United States
(12) Patent Application Publication
(10) Pub. No.: US 2024/0042524 A1
(43) Pub. Date: Feb. 8, 2024

(54) LEVERAGING PRINTING STANDOFF DISTANCE IN THREE-DIMENSIONAL PRINTING TO ENHANCE PART SEPARATION AND SYSTEM AND METHODS THEREOF

(71) Applicant: XEROX CORPORATION, NORWALK, CT (US)

(72) Inventor: Dinesh Krishna Kumar Jayabal, Rochester, NY (US)

(73) Assignee: XEROX CORPORATION, NORWALK, CT (US)

(21) Appl. No.: 17/883,088

(22) Filed: Aug. 8, 2022

(51) Int. Cl. B22F 10/22; B22F 12/53; B22F 12/00; B22F 12/70; B22F 10/32; B22F 10/38; B33Y 10/00; B33Y 30/00; B33Y 70/00

(52) U.S. Cl. CPC B22F 10/22; B22F 12/53; B22F 12/222; B22F 12/70; B22F 10/32; B22F 10/38; B33Y 10/00; B33Y 30/00; B33Y 70/00; B22F 2201/03; B22F 2301/052; B22F 2302/25; B22F 2301/15

(57) ABSTRACT

A method of forming a three-dimensional printed part is disclosed which includes positioning a printing system at a first standoff position under a first condition. The method also includes positioning the printing system at a second standoff position under a second condition. The method of forming a three-dimensional printed part may include where one of the first condition and second condition may include a printing material drop being ejecting onto a surface of a substrate. The printing material drop may include a metal, a metallic alloy, or a combination thereof. A printing system and a three-dimensional printed part employed the method is also disclosed.

### TECHNICAL FIELD

The present teachings relate generally to liquid ejectors in drop-on-demand (DOD) printing and, more particularly, to methods and apparatus for printing three-dimensional parts for use within a DOD printer.

### BACKGROUND

A drop-on-demand (DOD) or three-dimensional (3D) printer builds (e.g., prints) a 3D object from a computer-aided design (CAD) model, usually by successively depositing material layer upon layer. A drop-on-demand (DOD) printer, for example, one that prints a metal or metal alloy, ejects a small drop of liquid aluminum alloy when a firing pulse is applied. Using this technology or others using various printing materials, a 3D part can be created by ejecting a series of drops which bond together to form a continuous part. For example, a first layer may be deposited upon a substrate, and then a second layer may be deposited upon the first layer. One particular type of 3D printer is a magnetohydrodynamic (MHD) printer, which is suitable for jetting liquid metal layer upon layer which bond together to form a 3D metallic object. Magnetohydrodynamic refers to the study of the magnetic properties and the behavior of electrically conducting fluids.

Furthermore, 3D printing technology is well known for enabling the manufacture of complex 3D designs which otherwise could not be made using traditional methods such as machining, casting, or injection molding. This ability is made possible through a common trait that all the 3D printing processes share, which is to divide a given geometry along the printing direction into multiple two-dimensional (2D) layers and print one layer at a time. In this approach, it can deposit the molten droplets on a heated build plate or substrate precisely using computer numerical control. In such an arrangement, the importance of the first layer cannot be understated as the successful printing of the subsequent layers to form the remainder of the three-dimensional part depend on it. Currently, there are instances where parts can fail to release from the build plate after printing due to strong welding or in other instances, the droplets fail to stick to the build plate while printing the first layer. Both situations are detrimental to part quality and should be mitigated.

Therefore, it is desirable for the first layer to adhere well with the build plate during printing and at the same time enable part release after print completion. A method of and apparatus for forming three-dimensional parts while maintaining appropriate is needed to produce a wider variety of features in 3D printed parts and avoid issues with reliability due to either poor or excessive adhesion of a three-dimensional part to substrates or other structural features.

### SUMMARY

The following presents a simplified summary in order to provide a basic understanding of some aspects of one or more embodiments of the present teachings. This summary is not an extensive overview, nor is it intended to identify key or critical elements of the present teachings, nor to delineate the scope of the disclosure. Rather, its primary purpose is merely to present one or more concepts in simplified form as a prelude to the detailed description presented later.

A method of forming a three-dimensional printed part is disclosed. The method also includes positioning a printing system at a first standoff position under a first condition. The method also includes positioning the printing system at a second standoff position under a second condition. Implementations of the method of forming a three-dimensional printed part may include where one of the first condition and second condition may include a printing material drop being ejecting onto a surface of a substrate. The printing material drop may include a metal, a metallic alloy, or a combination thereof. One of the first condition and second condition may include ejecting a printing material drop onto a predetermined location of a three-dimensional printed part. One of the first condition and second condition may include ejecting a printing drop onto a surface associated with a breakaway layer of a three-dimensional printed part. The method of forming a three-dimensional printed part may include moving a nozzle of the printing system from a first standoff position to a second standoff position while forming a three-dimensional printed part. The method of forming a three-dimensional printed part may include moving the nozzle in a z-direction to the first standoff position. The method of forming a three-dimensional printed part may include moving the nozzle in a z-direction to the second standoff position. The method of forming a three-dimensional printed part may include moving a substrate in a z-direction to the first standoff position. The method of forming a three-dimensional printed part may include moving a substrate in a z-direction to the second standoff position.

Another method of forming a three-dimensional printed part is disclosed, which includes positioning a printing system such that a nozzle of an ejector for the printing system is at a first standoff position relative to a substrate, ejecting a plurality of liquid metal print material drops from the nozzle to form a first layer of a three-dimensional printed part onto the substrate, positioning the printing system such that the nozzle is at a second standoff position relative to a top surface of the first layer, and printing one or more layers of the three-dimensional printed part from the second standoff position and onto the first layer.

Implementations of the method of forming a three-dimensional printed part may include removing the three-dimensional printed part from the substrate. The substrate may include a top surface layer may include nickel oxide. The method of forming a three-dimensional printed part may include moving the nozzle or printhead in a z-direction to adjust to the first standoff position. The method of forming a three-dimensional printed part may include moving the nozzle or printhead in a z-direction to adjust to the second standoff position. The method of forming a three-dimensional printed part may include moving the substrate in a z-direction to adjust to the first standoff position. The method of forming a three-dimensional printed part may include moving the substrate in a z-direction to adjust to the second standoff position. The liquid metal print material may include a metal, a metallic alloy, or a combination thereof. The liquid metal print material forms an oxide layer on an outer surface of one or more of the plurality of liquid metal print material drops in atmospheric conditions. The liquid metal print material may include aluminum. The method of forming a three-dimensional printed part may include controlling a quantity of ambient oxygen to oxidize one or more of the plurality of liquid metal print material drops as they are ejected. The first standoff position is from about 25 mm to about 50 mm between the nozzle and the substrate. The second standoff position is from about 8 mm to about 10 mm between the nozzle and a top of the first layer of the three-dimensional printed part.

A method of forming a breakaway layer between a support structure and a three-dimensional printed part is disclosed. The method also includes positioning a printing system such that a nozzle of an ejector for the printing system is at a first standoff position relative to a top layer of a support structure, ejecting a plurality of liquid metal print material drops from the nozzle to form a breakaway layer onto the support structure, positioning the printing system such that the nozzle is at a second standoff position relative to a top surface of the breakaway layer, and printing one or more layers of the three-dimensional printed part from the second standoff position and onto the breakaway layer.

Implementations of the method of forming a breakaway layer between a support structure and a three-dimensional printed part may include ejecting a plurality of liquid metal print material drops from the nozzle to form additional breakaway layers onto the support structure. The first standoff position is from about 25 mm to about 50 mm between the nozzle and the top layer of a support structure. The second standoff position is from about 8 mm to about 10 mm between the nozzle and a top of the breakaway layer of the three-dimensional printed part.

A printing system is disclosed. The printing system includes a substrate. The system also includes an ejector for jetting a print material onto the substrate, may include a structure defining an inner cavity, and a nozzle orifice in connection with the inner cavity and configured to eject one or more droplets of liquid print material, and the system also includes where the ejector is configured to print a first layer of a three-dimensional printed part from a first standoff position relative to the substrate. The system also includes where the ejector is configured to print one or more remaining layers onto the first layer from a second standoff position relative to a top surface of the first layer.

Implementations of the printing system where the print material may include a metal, a metallic alloy, or a combination thereof. The printing material forms an oxide layer when exposed to atmospheric conditions. The substrate may include a top surface layer of nickel oxide. The printing system further may include a substrate control motor.

A three-dimensional printed part is disclosed. The three-dimensional printed part also includes a first layer of a metal print material disposed onto a substrate, a second layer of the metal print material disposed onto the first layer of the metal print material, and where the first layer of the metal print material may include an oxidizing metal, and a surface of the substrate may include an oxidizing metal.

Implementations of the three-dimensional printed part include where the metal print material may include aluminum. The surface of the substrate may include nickel. The first layer of the metal print material is disposed onto the substrate from a distance between a nozzle of a printing system and the substrate of from about 25 mm and about 40 mm.

The features, functions, and advantages that have been discussed can be achieved independently in various implementations or can be combined in yet other implementations further details of which can be seen with reference to the following description.

### BRIEF DESCRIPTION OF THE DRAWINGS

The accompanying drawings, which are incorporated in and constitute a part of this specification, illustrate embodiments of the present teachings and together with the description, serve to explain the principles of the disclosure. In the figures:

FIG. 1A depicts a schematic cross-sectional view of a single liquid metal ejector jet of a 3D printer (e.g., a MEM printer and/or multi jet printer), in accordance with the present disclosure.

FIG. 1B depicts a schematic view demonstrating a standoff position of a nozzle in a printing system, in accordance with the present disclosure.

FIGS. 2A-2C depict side cross-sectional views of several geometries of a three-dimensional printed part, in accordance with the present disclosure.

FIG. 3 depicts a top view of the removal of an oxide layer after parts are printed using a method of printing, in accordance with the present disclosure.

FIGS. 4A-4B depict top views of a three-dimensional printed part printed using a method of printing, in accordance with the present disclosure.

FIG. 5 is a flowchart illustrating a method of forming a three-dimensional printed part, in accordance with the present disclosure.

FIG. 6 is a flowchart illustrating a method of forming a breakaway layer between a support structure and a three-dimensional printed part, in accordance with the present disclosure.

It should be noted that some details of the figures have been simplified and are drawn to facilitate understanding of the present teachings rather than to maintain strict structural accuracy, detail, and scale.

### DETAILED DESCRIPTION

Reference will now be made in detail to exemplary examples of the present teachings, examples of which are illustrated in the accompanying drawings. Wherever possible, the same reference numbers will be used throughout the drawings to refer to the same, similar, or like parts.

Examples of the present disclosure provide a printing approach that enables the printing of three-dimensional parts or components with improved adhesion characteristics with respect to build plates or substrates, or combinations thereof. As issues of poor adhesion in metal jet printing as described can result from the condition or age of a build plate after prolonged exposure to elevated temperatures, excessive adhesion can also result from other this aging of the build plate or substrate. The method and apparatus of the present disclosure provides an adjustment of the printing system such that a nozzle of an ejector for the printing system is at a first standoff position relative to a substrate, build plate, or other feature such as but not limited to a support structure during a first condition. The ejection of an initial layer onto the substrate, build plate, or other feature with the nozzle at the standoff position to begin formation of a three-dimensional printed part is followed by positioning the printing system such that the nozzle is at a second standoff position relative to a top surface of the first layer and continuing to print a part or feature of a three-dimensional part with the nozzle at the second standoff position during a second condition. Utilizing this method as described herein, the three-dimensional part can be printed and the drops of the initial layer will have adequate adhesion to the substrate, build plate, or other feature and when the part is completed, the part can be removed without the use of excessive force or other separation means from the substrate, build plate, or another feature during this first condition. For the purposes of this disclosure, the second standoff position is defined initially as a nominal distance between the nozzle and the substrate or build plate or other feature, such as but not limited to a support structure. A z-distance is defined as an absolute distance between the nozzle and the substrate surface. As a part is built onto the surface, the z-distance will increase during a print job relative to the substrate but will remain constant from the nozzle to the top surface of another layer or part feature that print material is being deposited upon. In this manner, z-distance increases in steps of the layer height as a part is printed. The first or second standoff position is a transitory position or distance between the nozzle and the substrate or build plate or other feature that is adjusted in certain examples to adjust or tailor the interfacial adhesion between an impinging molten metal print material drop or droplet and a surface upon which the drop or droplet is jetted onto. In certain examples, the distance of a standoff position is larger as compared to the distance of a z-distance position or a second standoff position. In some examples, a z-distance positional distance may be larger or the same as a first standoff position or a second standoff position distance. This may be dependent upon the specific metal or alloy in the print material or system operating temperature or other operating parameters. Most of the time when a part is being made, there is a constant standoff distance. However, under certain build conditions, such as when depositing the first layer(s) of metal on the surface, a higher standoff distance is used, longer or higher than the usual one, to overcome certain problems such as droplet bouncing or excessive adhesion to a build plate. Without wishing to be bound by any particular theory, it may be that a longer standoff distance provides the droplet more time to cool before it hits the surface.

In printing systems of the present disclosure, the build plate can be placed upon or on top of a heat transfer unit, which has a heating element providing heat energy to the plate and/or substrate. In certain examples, the build plate can be made of brass and can be coated with nickel to promote the wetting of molten aluminum droplets when they impinge on the build plate. Before being used for the first time, new build plates are typically seasoned at 475° C. for at least an hour by placing them over the heat transfer unit. At this elevated temperature, the nickel coating undergoes oxidation and forms a nickel oxide layer over the build plate. The oxide layer usually has various shades of blue, violet, or green colors. In certain examples, the substrate or plate surface is coated with an oxidizing metal. In other examples, the printing material, often at elevated temperatures, forms an oxide layer when exposed to atmospheric conditions, or when subjected to continuous heating.

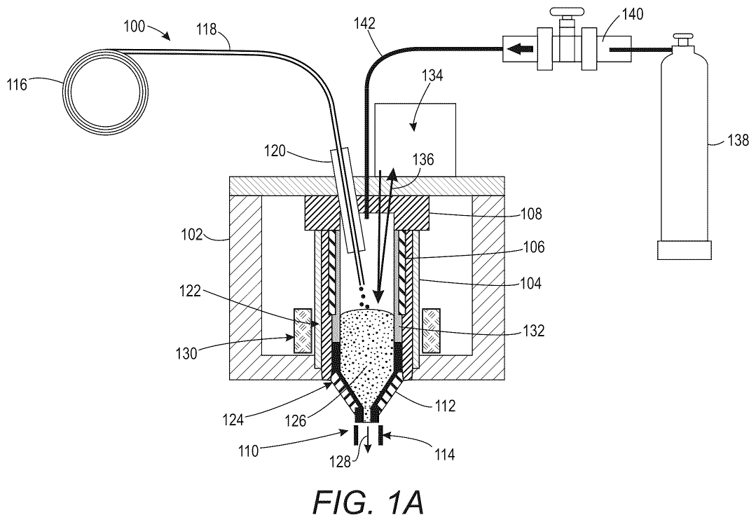

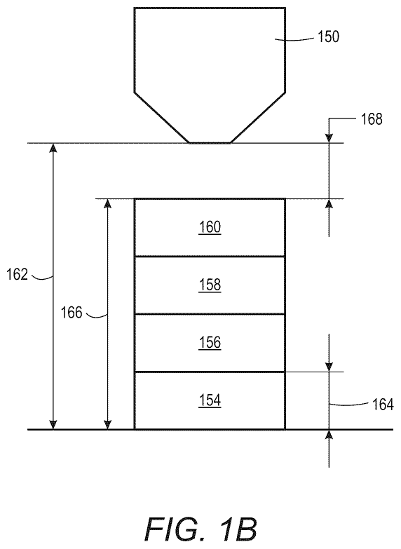

FIG. 1A depicts a schematic cross-sectional view of a single liquid metal ejector jet of a 3D printer (e.g., a MHD printer and/or multi jet printer), in accordance with the present disclosure. FIG. 1A shows a portion of a type of drop-on-demand (DOD) or three-dimensional (3D) printer 100. The 3D printer or liquid ejector jet system 100 may include an ejector (also referred to as a body or pump chamber, or a “one-piece” pump) 104 within an outer ejector housing 102, also referred to as a lower block. The ejector 104 may define an inner volume 132 (also referred to as an internal cavity or an inner cavity). A printing material 126 may be introduced into the inner volume 132 of the ejector 104. The printing material 126 may be or include a metal, a polymer, or the like. It should be noted that alternate jetting technology aside from MHD as described herein may be necessary depending on the nature and properties of the print material used in examples of the present disclosure. For example, the printing material 126 may be or include aluminum or aluminum alloy, introduced via a printing material supply 116 or spool of a printing material wire feed 118, in this case, an aluminum wire. The liquid ejector jet system 100 further includes a first inlet 120 within a pump cap or top cover portion 108 of the ejector 104 whereby the printing material wire feed 118 is introduced into the inner volume 132 of the ejector 104. The ejector 104 further defines a nozzle 110, an upper pump 122 area and a lower pump 124 area. One or more heating elements 112 are distributed around the pump chamber 104 to provide an elevated temperature source and maintain the printing material 126 in a molten state during printer operation. The heating elements 112 are configured to heat or melt the printing material wire feed 118, thereby changing the printing material wire feed 118 from a solid state to a liquid state (e.g., printing material 126) within the inner volume 132 of the ejector 104. The three-dimensional 3D printer 100 and ejector 104 may further include an air or argon shield 114 located near the nozzle 110, and a water coolant source 130 to further enable nozzle and/or ejector 104 temperature regulation. The liquid ejector jet system 100 further includes a level sensor 134 system which is configured to detect the level of molten printing material 126 inside the inner volume 132 of the ejector 104 by directing a detector beam 136 towards a surface of the printing material 126 inside the ejector 104 and reading the reflected detector beam 136 inside the level sensor 134.

The 3D printer 100 may also include a power source, not shown herein, and one or more metallic coils 106 enclosed in a pump heater that are wrapped at least partially around the ejector 104. The power source may be coupled to the coils 106 and configured to provide an electrical current to the coils 106. An increasing magnetic field caused by the coils 106 may cause an electromotive force within the ejector 104, that in turn causes an induced electrical current in the printing material 126. The magnetic field and the induced electrical current in the printing material 126 may create a radially inward force on the printing material 126, known as a Lorentz force. The Lorenz force creates a pressure at an inlet of a nozzle 110 of the ejector 104. The pressure causes the printing material 126 to be jetted through the nozzle 110 in the form of one or more liquid drops 128.

The 3D printer 100 may also include a substrate, not shown herein, that is positioned proximate to (e.g., below) the nozzle 110. The substrate may include a heating element, or alternatively be constructed of brass or other materials [please define other substrate materials]. In certain examples, the substrate may further include a build plate made of brass which can be coated with nickel to promote the wetting of molten aluminum droplets when they impinge on the build plate. Build plates in certain examples, may be made from alternate materials, such as molybdenum. It should be noted that while no coating need be applied to the molybdenum plate, once heated above 450° C. molybdenum oxide can be formed. The ejected drops 128 may land on the substrate and solidify to produce a 3D object. The 3D printer 100 may also include a substrate control motor that is configured to move the substrate while the drops 128 are being jetted through the nozzle 110, or during pauses between when the drops 128 are being jetted through the nozzle 110, to cause the 3D object to have the desired shape and size. The substrate control motor may be configured to move the substrate in one dimension (e.g., along an X axis), in two dimensions (e.g., along the X axis and a Y axis), or in three dimensions (e.g., along the X axis, the Y axis, and a Z axis). In another example, the ejector 104 and/or the nozzle 110 may be also or instead be configured to move in one, two, or three dimensions. In other words, the substrate may be moved under a stationary nozzle 110, or the nozzle 110 may be moved above a stationary substrate. In yet another example, there may be relative rotation between the nozzle 110 and the substrate around one or two additional axes, such that there is four or five axis position control. In certain examples, both the nozzle 110 and the substrate may move. For example, the substrate may move in X and Y directions, while the nozzle 110 moves up and/or down in a Z direction. In case of a nozzle 110 moving, the nozzle 110 and other printhead assembly components can include a nozzle or printhead motor control, not shown herein.

The 3D printer 100 may also include one or more gas-controlling devices, which may be or include a gas source 138. The gas source 138 may be configured to introduce a gas. The gas may be or include an inert gas, such as helium, neon, argon, krypton, and/or xenon. In another example, the gas may be or include nitrogen. The gas may include less than about 10% oxygen, less than about 5% oxygen, or less than about 1% oxygen. In at least one example, the gas may be introduced via a gas line 142 which includes a gas regulator 140 configured to regulate the flow or flow rate of one or more gases introduced into the three-dimensional 3D printer 100 from the gas source 138. For example, the gas may be introduced at a location that is above the nozzle 110 and/or the heating element 112. This may allow the gas (e.g., argon) to form a shroud/sheath around the nozzle 110, the drops 128, the 3D object, and/or the substrate to reduce/prevent the formation of oxide (e.g., aluminum oxide) in the form of an air shield 114. Controlling the temperature of the gas may also or instead help to control (e.g., minimize) the rate that the oxide formation occurs.

The liquid ejector jet system 100 may also include an enclosure 102 that defines an inner volume (also referred to as an atmosphere). In one example, the enclosure 102 may be hermetically sealed. In another example, the enclosure 102 may not be hermetically sealed. In one example, the ejector 104, the heating elements 112, the power source, the coils, the substrate, additional system elements, or a combination thereof may be positioned at least partially within the enclosure 102. In another example, the ejector 104, the heating elements 112, the power source, the coils, the substrate, additional system elements, or a combination thereof may be positioned at least partially outside of the enclosure 102. While the liquid ejector jet system 100 shown in FIG. 1 is representative of a typical liquid ejector jet system 100, locations and specific configurations and/or physical relationships of the various features may vary in alternate design examples. Printing systems as described herein may alternatively include other printing materials such as plastics or other ductile materials that are non-metals. The print material may include a metal, a metallic alloy, or a combination thereof. A non-limiting example of a printing material may include aluminum. Exemplary examples of printing systems of the present disclosure may include an ejector for jetting a print material, including a structure defining an inner cavity, and a nozzle orifice in connection with the inner cavity and configured to eject one or more droplets of liquid print material, wherein the ejector is configured to print a first layer of a three-dimensional printed part from a standoff position relative to the substrate and the ejector is configured to print one or more remaining layers onto the first layer from a second standoff position relative to a top surface of the first layer. In such examples, a nominal printing distance of the nozzle or second standoff distance from any given layer is from about 8 mm to about 10 mm. The z-distance position relative to the substrate increases as the part is built.

FIG. 1B depicts a schematic view demonstrating a standoff position of a nozzle in a printing system, in accordance with the present disclosure. As nozzle 150 deposits one or more layers of drops onto a print bed or substrate 152, a first print layer 154, a second print layer 156, a third print layer 158, and a fourth print layer 160 are shown accumulated to form a portion of a printed part. Indicated in FIG. 1B is a z-height or z-distance 162, which is the distance between the nozzle 150 and the substrate 152. Z-height or z-distance 162 is the sum of a part height 166 at any time and a nozzle standoff distance 168. A layer height 164 indicates a height for each layer printed using the nozzle 150. The part height 166 is a total of the height of any layers of the part printed, which can also be referred to as the product of the number of layers printed and the layer height 164. A nozzle standoff distance 168 is indicated, which is a distance between the nozzle 150 and a top surface of a topmost layer 160 of a printed part. The standoff distance 168 is a distance between where a droplet starts its flight, in some examples a nozzle 150, and to where the droplet is intended to land in a given situation. Standoff distance 168 can be further defined as an absolute distance between an exit position of a drop of printing material to an intended landing location of a droplet. Therefore, method of printing or forming a three-dimensional printed part can include where positioning the printing system is at a first standoff position under a first condition and positioning the printing system such that the nozzle is at a second standoff position under a second condition. A first condition can include One of the first condition and second condition being ejecting onto a surface of the build plate. One of the first condition and second condition can include ejecting onto a predetermined location of a three-dimensional part being built, printed, or formed. One of the first condition and second condition can include being ejecting onto a surface or substrate associated with a breakaway layer of a workpiece or three-dimensional part being built, printed or formed.

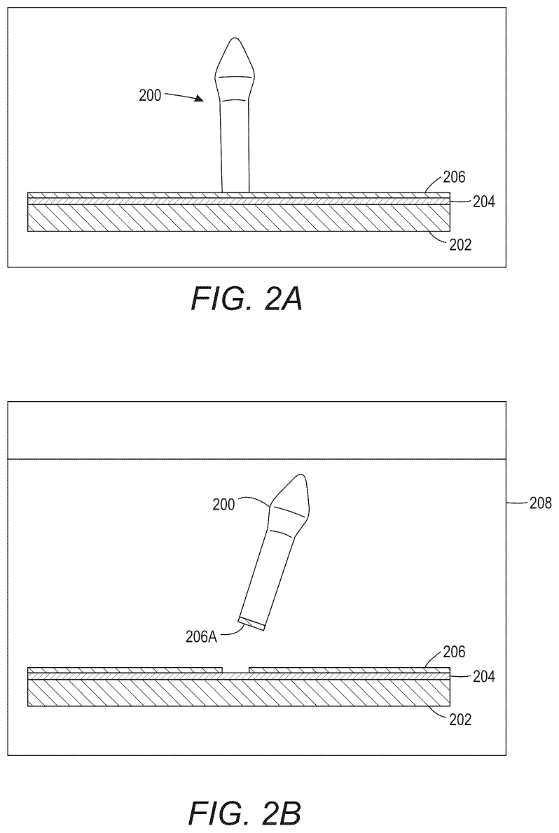

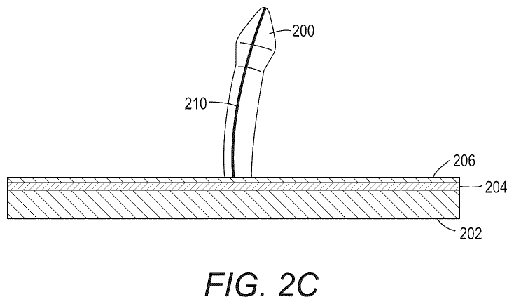

FIG. 2A-2C depict side cross-sectional views of several geometries of a three-dimensional printed part, in accordance with the present disclosure. FIG. 2A illustrates an example of a three-dimensional printed part 200 that has been printed onto a 202. The 202 is made of brass or alternately another suitable material as described herein and has a nickel coating 204 that has a top surface layer 206 of nickel oxide formed upon the nickel coating 204. FIG. 2B illustrates a three-dimensional printed part 200 having a stripped off top surface layer 206A of nickel oxide adhering to the three-dimensional printed part 200 after the three-dimensional part 200 is printed onto the top surface 206 of this nickel oxide layer. To separate the part 200 from the build plate 202, the build plate 202 along with the part 200 is submerged rapidly into a bath 208 containing room temperature water. As the coefficient of thermal expansion (CTE) values of the brass build plate 202 and the printed aluminum part 200 are different, the mismatch in shrinkage between the materials when rapidly cooled facilitates the release of the part 200 from the build plate 202. In this process, the underside of the printed part 200 takes a bit of nickel oxide top surface 206A of the build plate 202 along with it and where the nickel oxide layer 206 is stripped off, underlying nickel coating 204 is exposed on the build plate 202. In this manner, a small amount of the nickel coating 204 of the build plate is consumed after every print job. In exemplary examples, the CTE value difference between metals, i.e., build plate and printed part, is from about 1 ppm/° C. to about ppm/° C., or from about 6 ppm/° C. to about 10 ppm/° C., or from about 11 ppm/° C. to about 15 ppm/° C.

The plate 202 is then dried and heated back up to the operating temperature of 475° C. The exposed underlying nickel layer 204 gradually grows a top surface 206 of the nickel oxide layer once again. If the footprint of the next part to be printed is small as the one shown in FIG. 2A, its print location can be conveniently changed to utilize other areas of the build plate 202 where the nickel oxide top surface layer 206 is relatively intact. After going through a lot of print and water immersion and cooling cycles, the plate 202 becomes barren of the nickel coating 204 and will not be able to develop the required nickel oxide layer 206 for printing. This marks the end of the lifecycle for the build plate 202, and it must be sent for cleaning and recoating before it can be used again.

In some examples, the part 200 can refuse to separate from the build plate 202 while immersed into the water bath 208 owing to strong welding and applying significant force to facilitate removal oftentimes causes damage to the printed part 200 or the build plate 202. This can also lead to excessive stripping of the nickel layer 204 in clumps or large areas, causing significant damage. Also, in cases of parts having round features and no tool entry points, for example, to accommodate the bevel of a chisel, leveraging the part to separate it from the build plate causes issues. As shown in FIG. 2C, an indicator line 210 along printed part 200, that while intended to be perpendicular to the top surface 206 and the plate 202, is curved, illustrating a bending of the three-dimensional printed part as it is being removed from the plate 202 after printing. The excessive force required to remove the three-dimensional printed part 200 from the top surface 206 of the plate 202 has caused the three-dimensional printed part 200 to bend as indicated by the indicator line 210. It should be noted that this manual way of removing a printed part is possible for slender parts, i.e., taller parts having a smaller base area and hence the top of the part could be grabbed with a plier or other implement to apply the necessary lateral force to cause separation due to a small adhesion area to a plate.

In the system and methods described in the present disclosure, the printhead or nozzle first standoff position or distance can be increased to 30 mm to 40 mm to mitigate the issues of both excessive welding of the printed part to a new build plate as well as droplets bouncing from a well-used build plate. In certain examples, the first standoff position is from about 25 mm to about 50 mm, or from about 25 mm to about 40 mm, or from about 25 mm to about 35 mm. The standoff position can be compared to a nominal printing standoff position of from about 8 mm to about 10 mm relative to a substrate or top layer of a printed part.

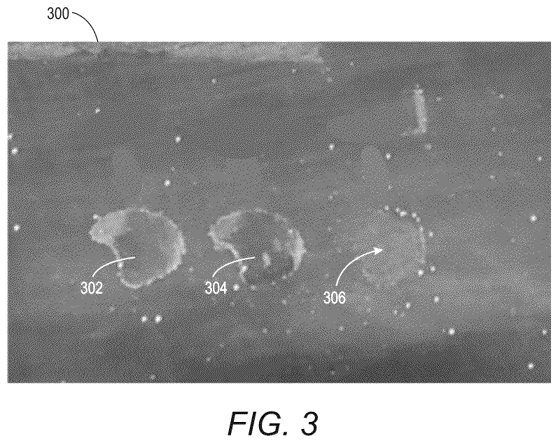

FIG. 3 depicts a top view of the removal of an oxide layer after parts are printed using a method of printing, in accordance with the present disclosure. On a top surface of a build plate 300, patches of stripped-off nickel oxide layer resembling the bottom of several printed parts are shown after part removal from the plate 300. A patch of stripped off build plate surface material 302 for a part printed with a first standoff position of 5 mm is shown, along with a second patch of stripped off build plate surface material 304 for a part printed with a first standoff position of 5 mm. Lastly, a third patch of stripped off build plate surface material 306 is shown for a part printed with a first standoff position of 40 mm. As noted during printing of the parts described in regard to FIG. 3, it was possible to snap off the part printed at from 40 mm easily without deforming the part. As illustrated in FIG. 3, the patch of stripped off build plate surface material 306 from the part printed from the 40 mm standoff is the result of a weaker adhesion of the part to the build plate 300 and consequently the nickel oxide layer removed is weaker compared to the 5 mm stripped off build plate surface patches 302, 304.

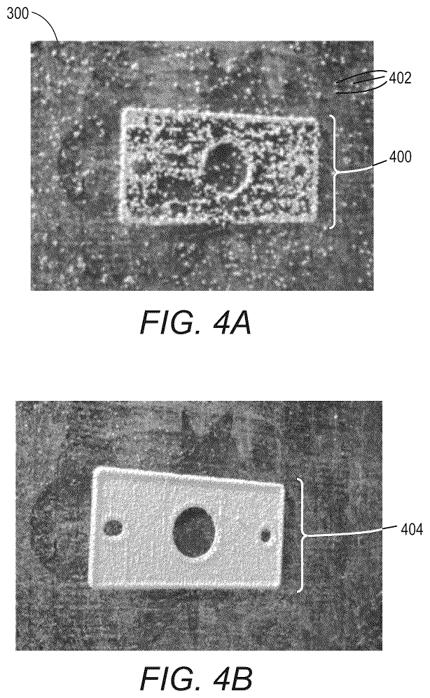

FIGS. 4A-4B depict top views of a three-dimensional printed part printed using a method of printing, in accordance with the present disclosure. In examples, where a plate is older or has been used for a longer period of time, the depleted nickel layer owing to multiple print cycles will not be able to provide an adequate amount of nickel required to oxidize to form a nickel oxide layer, which can cause one or more drops or droplets 402 of a first printed layer 404 to rebound from or bounce off of a build plate 406 as shown in FIG. 4A. In this example and other examples exhibiting a similar defect, the print head nozzle is 8 mm away from the build plate 406 while printing and the bouncing droplets 402 at this print head standoff distance from the substrate can stick to the higher temperature area around an orifice of the nozzle and potentially lead to poor jetting due to undesirable wetting of the molten print material around the orifice.

As previously described, there is some control over the part adhesion strength by varying the printhead standoff distance. This attribute can be leveraged to intentionally create weaker adhesion of individually jetted droplets allowing for the removal of parts from build plate without additional or excessive force during part release in a water bath. A higher printhead standoff distance used in improving part removal could be beneficial in other manners during three-dimensional part printing with liquid or molten metal print materials. During the use of plates that have been subjected to multiple print and part separation cycles, printing from an increased standoff position significantly reduces droplets bouncing from or rebounding from a plate surface. A first layer 404 as shown in FIG. 4B when printed from a standoff position at a height of 30 mm reduced most of the bouncing observed as compared to when a similar print was printed or jetted from a nominal standoff position.

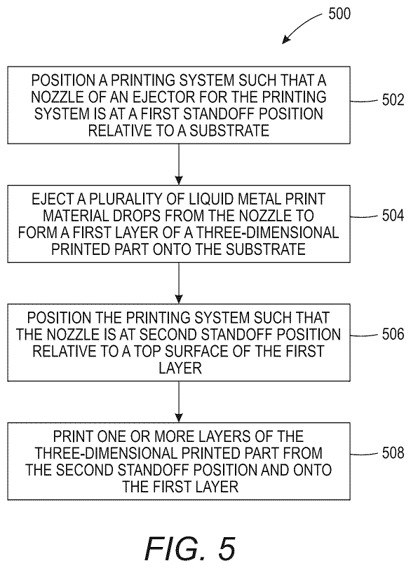

FIG. 5 is a flowchart illustrating a method of forming a three-dimensional printed part, in accordance with the present disclosure. A method of forming a three-dimensional printed part 500 includes a step to adjust a printing system such that a nozzle of an ejector for the printing system is at a first standoff position relative to a substrate 502, followed by ejecting a plurality of liquid metal print material drops from the nozzle to form a first layer of a three-dimensional printed part onto the substrate 504. Next the printing system is adjusted such that the nozzle is at a second standoff position relative to a top surface of the first layer 506, and one or more layers of the three-dimensional printed part is printed from the second standoff position and onto the first layer 508. In certain examples, the method 500 includes removing the three-dimensional printed part from the substrate. The substrate can include a top surface layer composed of, in part, a metal oxide layer, and in particular, nickel oxide. The adjustment of the printing system to a first standoff position can include moving the nozzle or printhead in a z-direction to adjust to the first standoff position, moving the nozzle or printhead in a z-direction to adjust to the second standoff position, moving the substrate in a z-direction to adjust to the first standoff position, moving the substrate in a z-direction to adjust to the second standoff position, or any combination thereof. In certain examples, the print material comprises a metal, a metallic alloy, or a combination thereof. In other examples, the print material forms an oxide layer on an outer surface of the drop in atmospheric conditions during or after jetting or ejecting the print material from the nozzle of the printing system. The print material, in certain examples, includes aluminum. Certain examples of the printing method include where a CTE of the printing material part and the build plate are dissimilar. The method of forming a three-dimensional printed part 500 can also include controlling a quantity of ambient oxygen or other atmospheric gas to oxidize one or more of the plurality of liquid metal print material drops as they are ejected. Alternatively, a quantity of ambient oxygen or other atmospheric gas can be delivered towards a build plate or substrate to oxidize a surface layer of metal on the plate or substrate. In exemplary examples, the first standoff position is from about 25 mm to about 50 mm between the nozzle and the substrate. In other exemplary examples, the second standoff position is from about 8 mm to about 10 mm between the nozzle and a top of the first layer of the three-dimensional printed part.

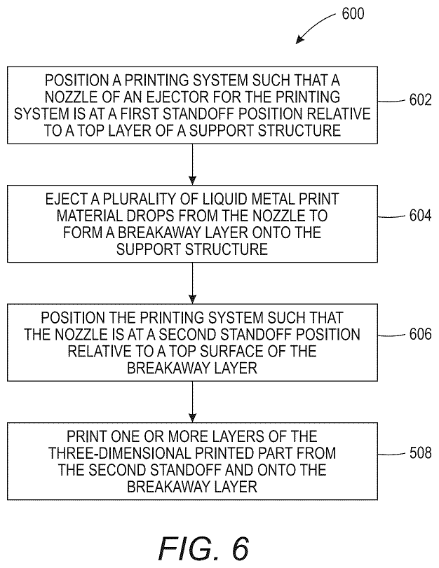

FIG. 6 is a flowchart illustrating a method of forming a breakaway layer between a support structure and a three-dimensional printed part, in accordance with the present disclosure. A breakaway layer is a printed layer or plurality of layers of a three-dimensional part placed at interfaces where the part is intended to be cleaved or separated after printing. This breakaway layer can be located within a part between portions of a printed part, between a part and a substrate or plate, between a portion of a part and a support structure, or a combination thereof. A method of forming a breakaway layer between a support structure and a three-dimensional printed part 600, utilizing the methods and system as described herein include positioning a printing system such that a nozzle of an ejector for the printing system is at a first standoff position relative to a top layer of a support structure 602 and ejecting a plurality of liquid metal print material drops from the nozzle to form a breakaway layer onto the support structure 604. Next, the printing system is adjusted such that the nozzle is at a second standoff position relative to a top surface of the breakaway layer 606 and one or more layers of the three-dimensional printed part is printed by ejection of one or more droplets from the second standoff position and onto the breakaway layer 608. The method 600 can include ejecting a plurality of liquid metal print material drops from the nozzle to form additional breakaway layers onto the support structure. The first standoff position used in the method 600 can be from about 25 mm to about 50 mm between the nozzle and the top layer of a support structure or the second standoff position can be from about 8 mm to about 10 mm between the nozzle and a top of the breakaway layer of the three-dimensional printed part.

Advantages of the present disclosure include the minimization of additional special setup or equipment for printing systems of the present disclosure. The method can be performed in a 3D metal printing system by positioning the standoff distance of the printhead nozzle while printing the first layer and thereafter during the printing of subsequent layers. In this manner, part adhesion strength can be controlled by varying the printhead standoff distance. Furthermore, drops or droplets bouncing during the printing of one or more layers of three-dimensional printed parts can be mitigated using an adjusted, and in some examples, higher standoff distance. This method minimizes damage to three-dimensional parts or build plates during part separation by avoiding or minimizing the usage of mechanical removal tools or excessive force associated therewith. Additional advantages of the method described in the present disclosure include extended plate life, minimized removal of clumps or large areas of nickel oxide due to strong adhesion of the part to the build plate printed without use of the present system or method. This controlled weakening of an initial first layer adhesion through hybrid stand-off distances for the first layer can be provided by the methods and systems described herein. In some examples, every other droplet in the g-code that directs printing operations can be printed with one standoff distance during the first pass and the rest of the droplets in other layers can be printed with a different standoff distance during second and subsequent passes. In examples, the standoff distance a droplet or layer of droplets is ejected from can influence a rate of cooling, oxidation of the droplets, or resulting tensile strength within a part as the droplets impinge upon a surface or weld into a previous layer, subsequent layer, or adjacent droplet within a three-dimensional printed part, build plate, or support structure.

While the present teachings have been illustrated with respect to one or more implementations, alterations and/or modifications may be made to the illustrated examples without departing from the spirit and scope of the appended claims. For example, it may be appreciated that while the process is described as a series of acts or events, the present teachings are not limited by the ordering of such acts or events. Some acts may occur in different orders and/or concurrently with other acts or events apart from those described herein. Also, not all process stages may be required to implement a methodology in accordance with one or more aspects or embodiments of the present teachings. It may be appreciated that structural objects and/or processing stages may be added, or existing structural objects and/or processing stages may be removed or modified. Further, one or more of the acts depicted herein may be carried out in one or more separate acts and/or phases. Furthermore, to the extent that the terms “including,” “includes,” “having,” “has,” “with,” or variants thereof are used in either the detailed description and the claims, such terms are intended to be inclusive in a manner similar to the term “comprising.” The term “at least one of” is used to mean one or more of the listed items may be selected. Further, in the discussion and claims herein, the term “on” used with respect to two materials, one “on” the other, means at least some contact between the materials, while “over” means the materials are in proximity, but possibly with one or more additional intervening materials such that contact is possible but not required. Neither “on” nor “over” implies any directionality as used herein. The term “conformal” describes a coating material in which angles of the underlying material are preserved by the conformal material. The term “about” indicates that the value listed may be somewhat altered, as long as the alteration does not result in nonconformance of the process or structure to the illustrated embodiment. The terms “couple,” “coupled,” “connect,” “connection,” “connected,” “in connection with,” and “connecting” refer to “in direct connection with” or “in connection with via one or more intermediate elements or members.” Finally, the terms “exemplary” or “illustrative” indicate the description is used as an example, rather than implying that it is an ideal. Other embodiments of the present teachings may be apparent to those skilled in the art from consideration of the specification and practice of the disclosure herein. It is intended that the specification and examples be considered as exemplary only, with a true scope and spirit of the present teachings being indicated by the following claims.

What is claimed is:

1. A method of forming a three-dimensional printed part, comprising:
positioning a printing system at a first standoff position under a first condition; and
positioning the printing system at a second standoff position under a second condition.

2. The method of forming a three-dimensional printed part of claim 1, wherein one of the first condition and second condition comprises a printing material drop being ejecting onto a surface of a substrate.

3. The method of forming a three-dimensional printed part of claim 1, wherein one of the first condition and second condition comprises ejecting a printing material drop onto a predetermined location of a three-dimensional printed part.

4. The method of forming a three-dimensional printed part of claim 1, wherein one of the first condition and second condition comprises ejecting a printing drop onto a surface associated with a breakaway layer of a three-dimensional printed part.

5. The method of forming a three-dimensional printed part of claim 1, further comprising moving a nozzle of the printing system from a first standoff position to a second standoff position while forming a three-dimensional printed part.

6. The method of forming a three-dimensional printed part of claim 5, further comprising moving the nozzle in a z-direction to the first standoff position.

7. The method of forming a three-dimensional printed part of claim 5, further comprising moving the nozzle in a z-direction to the second standoff position.

8. The method of forming a three-dimensional printed part of claim 5, further comprising moving a substrate in a z-direction to the first standoff position.

9. The method of forming a three-dimensional printed part of claim 5, further comprising moving a substrate in a z-direction to the second standoff position.

10. The method of forming a three-dimensional printed part of claim 2, wherein the printing material drop comprises a metal, a metallic alloy, or a combination thereof.

11. A method of forming a three-dimensional printed part, comprising:
positioning a printing system such that a nozzle of an ejector for the printing system is at a first standoff position relative to a substrate;
ejecting a plurality of liquid metal print material drops from the nozzle to form a first layer of a three-dimensional printed part onto the substrate;
positioning the printing system such that the nozzle is at a second standoff position relative to a top surface of the first layer; and
printing one or more layers of the three-dimensional printed part from the second standoff position and onto the first layer.

12. The method of forming a three-dimensional printed part of claim 11, further comprising removing the three-dimensional printed part from the substrate.

13. The method of forming a three-dimensional printed part of claim 12, wherein the substrate comprises a top surface layer comprising nickel oxide.

14. The method of forming a three-dimensional printed part of claim 11, further comprising moving the nozzle or printhead in a z-direction to adjust to the first standoff position.

15. The method of forming a three-dimensional printed part of claim 11, further comprising moving the nozzle or printhead in a z-direction to adjust to the second standoff position.

16. The method of forming a three-dimensional printed part of claim 11, further comprising moving the substrate in a z-direction to adjust to the first standoff position.

17. The method of forming a three-dimensional printed part of claim 11, further comprising moving the substrate in a z-direction to adjust to the second standoff position.

18. The method of forming a three-dimensional printed part of claim 11, wherein the liquid metal print material comprises a metal, a metallic alloy, or a combination thereof.

19. The method of forming a three-dimensional printed part of claim 18, wherein the liquid metal print material forms an oxide layer on an outer surface of one or more of the plurality of liquid metal print material drops in atmospheric conditions.

20. The method of forming a three-dimensional printed part of claim 18, wherein the liquid metal print material comprises aluminum.

21. The method of forming a three-dimensional printed part of claim 11, further comprising controlling a quantity of ambient oxygen to oxidize one or more of the plurality of liquid metal print material drops as they are ejected.

22. The method of forming a three-dimensional printed part of claim 11, wherein the first standoff position is from about 25 mm to about 50 mm between the nozzle and the substrate.

23. The method of forming a three-dimensional printed part of claim 11, wherein the second standoff position is from about 8 mm to about 10 mm between the nozzle and a top of the first layer of the three-dimensional printed part.

24. A method of forming a breakaway layer between a support structure and a three-dimensional printed part, comprising:
positioning a printing system such that a nozzle of an ejector for the printing system is at a first standoff position relative to a top layer of a support structure;
ejecting a plurality of liquid metal print material drops from the nozzle to form a breakaway layer onto the support structure;
positioning the printing system such that the nozzle is at a second standoff position relative to a top surface of the breakaway layer; and
printing one or more layers of the three-dimensional printed part from the second standoff position and onto the breakaway layer.

25. The method of forming a breakaway layer between a support structure and a three-dimensional printed part of claim 24, further comprising ejecting a plurality of liquid metal print material drops from the nozzle to form additional breakaway layers onto the support structure.

26. The method of forming a breakaway layer between a support structure and a three-dimensional printed part of claim 24, wherein the first standoff position is from about 25 mm to about 50 mm between the nozzle and the top layer of a support structure.

27. The method of forming a breakaway layer between a support structure and a three-dimensional printed part of claim 24, wherein the second standoff position is from about 8 mm to about 10 mm between the nozzle and a top of the breakaway layer of the three-dimensional printed part.

28. A printing system, comprising:
a substrate;
an ejector for jetting a print material onto the substrate, comprising:
a structure defining an inner cavity; and
a nozzle orifice in connection with the inner cavity and configured to eject one or more droplets of liquid print material; and wherein:
the ejector is configured to print a first layer of a three-dimensional printed part from a first standoff position relative to the substrate; and
the ejector is configured to print one or more remaining layers onto the first layer from a second standoff position relative to a top surface of the first layer.

29. The printing system of claim 28, wherein the print material comprises a metal, a metallic alloy, or a combination thereof.

30. The printing system of claim 29, wherein the printing material forms an oxide layer when exposed to atmospheric conditions.

31. The printing system of claim 28, wherein the substrate comprises a top surface layer of nickel oxide.

32. The printing system of claim 28, wherein the printing system further comprises a substrate control motor.

33. A three-dimensional printed part, comprising:
a first layer of a metal print material disposed onto a substrate;
a second layer of the metal print material disposed onto the first layer of the metal print material; and wherein:
the first layer of the metal print material comprises an oxidizing metal; and
a surface of the substrate comprises an oxidizing metal.

34. The three-dimensional printed part of claim 33, wherein the metal print material comprises aluminum.

35. The three-dimensional printed part of claim 33, wherein the surface of the substrate comprises nickel.

36. The three-dimensional printed part of claim 33, wherein the first layer of the metal print material is disposed onto the substrate from a distance between a nozzle of a printing system and the substrate of from about 25 mm and about 40 mm.
